(19) United States
(12) Patent Application Publication
(10) Pub. No.: US 2005/0060932 A1
(43) Pub. Date: Mar. 24, 2005

(54) Cradle for rolling seed boxes

(75) Inventor: Thomas C. Ramp, Yates City, IL (US)

Correspondence Address: HUSCH & EPPENBERGER, LLC, 190 CARONDELET PLAZA, SUITE 600, ST. LOUIS, MO, 63105-3441, US

(73) Assignee: Thomas C. Ramp, Yates City, IL (US)

(21) Appl. No.: 10/942,268

(22) Filed: Sep. 16, 2004

Related U.S. Application Data
(60) Provisional application No. 60/505,645, filed on Sep. 24, 2003.

(51) Int. Cl. A01G 9/02

(52) U.S. Cl. 47/67

(57) ABSTRACT

Apparatus adapted for attachment to a conventional overhead lift device such as a crane or the like, includes a pair of movable side arms each attached to a respective end of a transverse member. Each side arm has attached thereto a respective engaging member for engaging lateral ribs of a first seed box for lifting the seed box. The apparatus further includes a pivoting connection for rotating the first seed box to an inverted orientation for positioning on a second seed box in a nested configuration for storage. The first seed box may also be positioned on the second seed box in a stacked configuration for receiving and storing seed by engaging and lifting the first seed box, rotating the first seed box to an upright orientation, and placing the first seed box on the second seed box.

### CROSS-REFERENCE TO RELATED APPLICATIONS

This application claims priority of provisional application 60/505,645 filed Sep. 24, 2003.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to the handling of large boxes and, more particularly, to an apparatus for manipulating and positioning a first seed box in a first nested position on a second smaller seed box for storage.

2. Related Art

The agricultural seed industry is rapidly moving away from the traditional bagged seed approach and toward the bulk handling of seed. To this end, large boxes made of high strength plastic are used for receiving and storing the seed prior to planting. In one approach, boxes of two different sizes may be stacked to receive a large quantity of seed, or nested when inverted for compact storage of the boxes when not in use. A bottom box has a solid bottom and an open top. A larger top box has an open top and an open lattice bottom. The larger box has a flange on its sides so that it may be stacked on the bottom box and thereby allow both boxes together to be filled with seed. After use, the larger box is “rolled” upside down, and lowered over the bottom box for low volume storage.

The boxes themselves are typically quite heavy, requiring at least two workers to position the boxes in either the stacked configuration for receiving seed or in the nested configuration for storage. These boxes are commonly referred to as collapsible bulk boxes.

Each of the paired boxes is typically capable of holding 50 bags of seed beans which weigh on the order of 50 lbs. each. For strength, the boxes are heavy, and have reinforcing fins or ribs molded into their sides. The fins are on the outside of the box and are typically formed in a criss cross lattice. The criss-crossed fins create multiple square recesses on the sides of the box.

Each box weighs in the range of 300 to 400 lbs. empty which makes it difficult for only two workers to handle and position the boxes in either the stacked or nested configuration. Frequently a third worker is required to handle these cumbersome, bulky containers. The relatively large weight and size of the boxes also increases the possibility of accidental injury to the workers handling the boxes and possible damage to the boxes themselves. Finally, the seed boxes are typically transported from the seed dealer to the customer's location for use in storing seed and then returned to the seed dealer for storage after use. Manual handling of these large, heavy seed boxes makes their transport difficult, labor intensive and expensive. Power or hydraulic handling is prohibitively expensive.

### SUMMARY OF THE INVENTION

It is in view of the above problems that the present invention was developed. The invention is an apparatus for positioning and manipulating large boxes, such as a seed box. The apparatus includes a first plate, a second plate, a transverse member connecting the first and second plates, a pin located at the distal end of each plate, and a hanger operatively connected to the transverse member. The plates and transverse member are dimensioned to position the pins for use as hinges to roll or invert the box. Selectable pin placement among the box ribs for ease of use and variable leverage is a novel adaptation making advantageous use of preexisting ribs.

In a corresponding method, the apparatus is connected to a lifting device and a large box having first and second portions. The apparatus connects to the first portion in such a way that when the apparatus is lifted by the lifting device the first portion is raised and automatically inverted. The lifting device is then used to lower the apparatus, and thereby the first portion, such that the second portion becomes nested within the first portion. The nested box saves space in storage and shipping.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a perspective view of the apparatus in a first embodiment;

FIG. 2 illustrates a perspective view of the apparatus in a second embodiment;

FIG. 3 illustrates a sectional view of the spring loaded pin;

FIG. 4 illustrates a perspective view of the apparatus as attached to a large box and in conjunction with an overhead lifting device; and

FIG. 5 illustrates a perspective view of the apparatus as used to nest a first box within a second box.

### DETAILED DESCRIPTION OF THE PREFERRED EMBODIMENTS

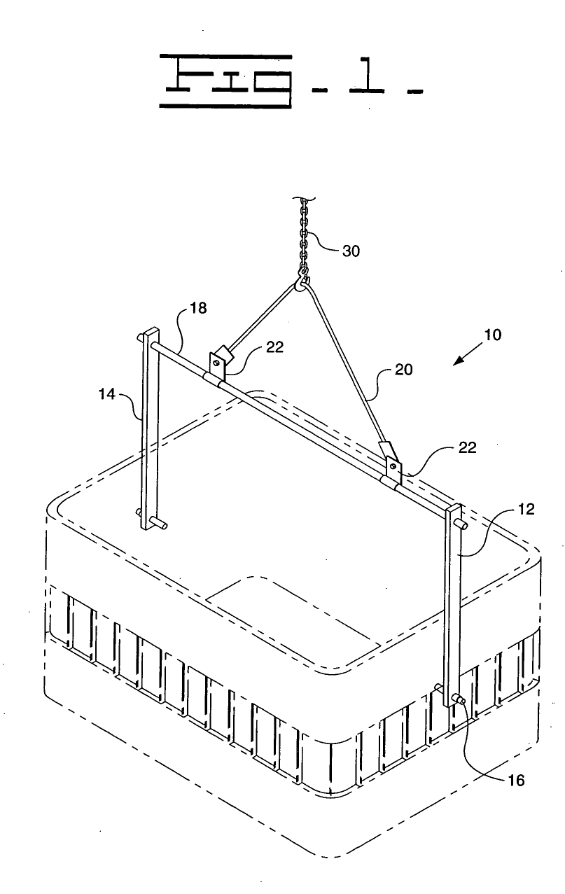

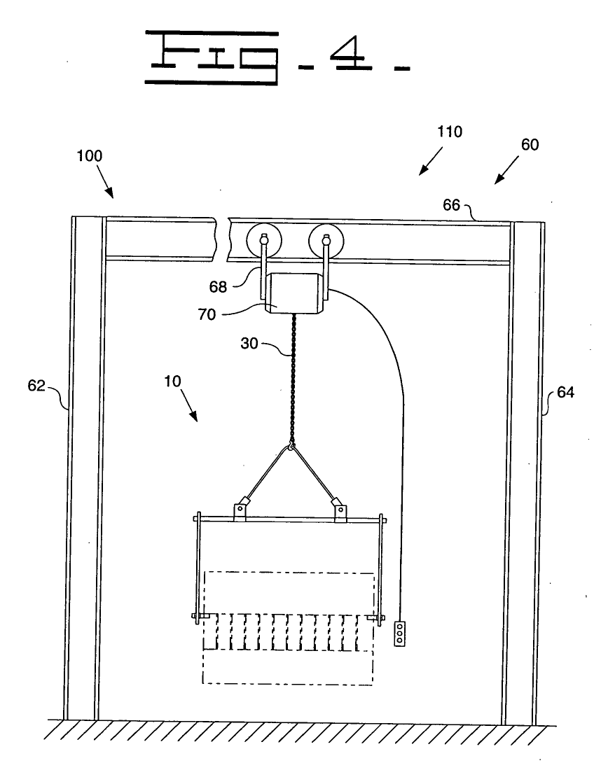

Referring to the accompanying drawings in which like reference numbers indicate like elements, FIG. 1 illustrates a cradle 10 for rolling large boxes, such as a seed box. The cradle 10 includes a first plate 12 and a second plate 14. Each plate 12, 14 includes a pin 16 at its distal end. The pins 16 operatively connect within a recess or corrugation of a large box. The plates 12, 14 are operatively connected by a transverse member 18 at their respective proximate ends. While in the depicted embodiment the transverse member 18 is shown as a rod, it could equally be a plate or a beam. A hanger 20 is operatively connected to the transverse member 18. In the depicted embodiment, the hanger 20 is attached to the transverse member 18 through the use of clamps 22. A lifting device 60 (best seen in FIG. 4), such as a forklift or an overhead crane, attaches to the hanger 20 to lift the cradle 10. In the depicted embodiment, the lifting device 60 is connected to the hanger 20 through the use of a chain 30.

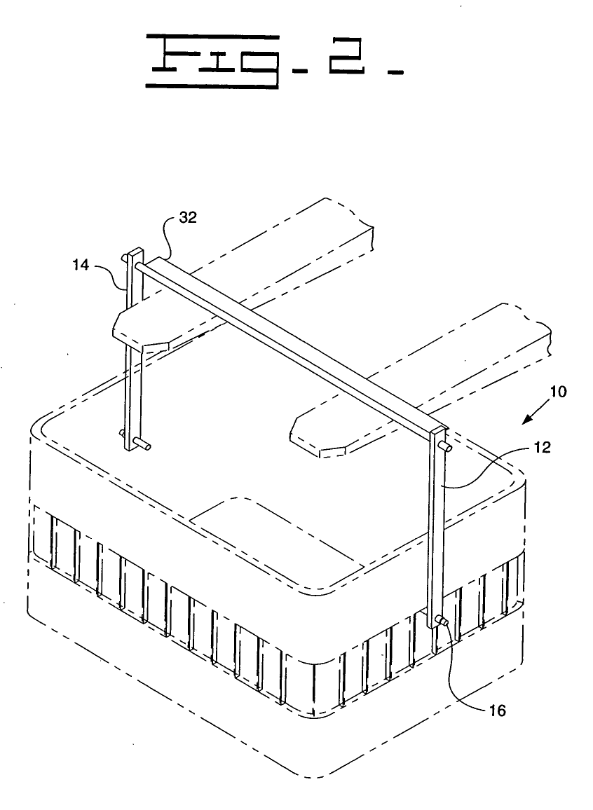

FIG. 2 illustrates a second embodiment of the apparatus. The depicted embodiment shows the pins 16 and the plates 12, 14. This second embodiment includes a cross member 32. The cross member 32 can be made from metal, such as steel or aluminum. The cross member 32 pivotally connects to the plates 12, 14 in such a way that when a lifting device, a forklift for example, lifts up on the cradle 10 that a flat surface of the cross member 32 contacts the lifting device. If, for example, a forklift is used to lift the cradle 10, the forks of the forklift contact a flat surface of the cross member 32 thereby allowing for greater stability and two convenient surfaces to clamp together.

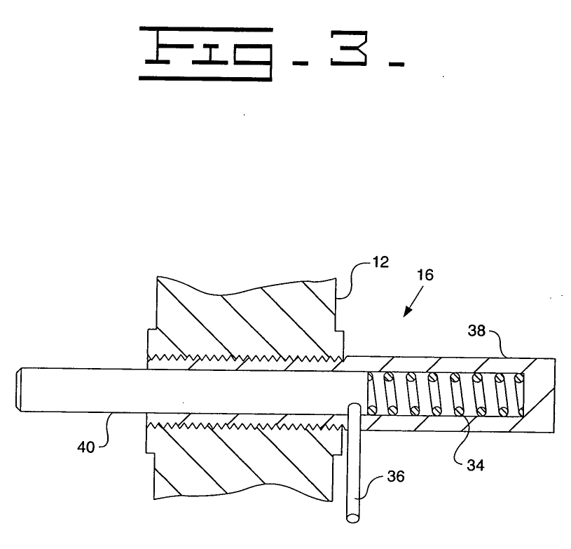

FIG. 3 illustrates a sectional view of the pin 16. The pin 16 includes a tube 38. A spring 34 and a shaft 40 are within the tube 38. The shaft 40 is operatively connected to the spring 34. A handle 36 is operatively connected to the shaft 40. For example, the shaft 40 can have a drilled hole and one end of the handle 36 is pressed into the hole. The tube 38 includes a slot (not shown) to allow movement of the handle. The tube 38 is operatively connected to the plate 12. The tube 38 can be made from pipe or similar material. In the depicted embodiment, both the tube 38 and the plate 12 are threaded and the tube 38 screws into the plate 12. In operation, a user (not shown) pulls on the handle thereby forcing the shaft 40 against the spring 34. The user moves the cradle 10, including the plate 12, into a desired position and releases the handle 36 whereby the spring 34 pushes the shaft 40 outward for engagement with, for example, a large box. While in the depicted embodiment the pin 16 is illustrated in combination with plate 12, those skilled in the art would understand that pin 16 may be used on first plate 12, second plate 14, or both plates 12, 14.

FIG. 4 illustrates the apparatus 10 used in conjunction with an overhead lifting device 60. In the depicted embodiment, a beam and trolley device 60 is shown, however, any overhead lifting device, such as a crane or A-frame gantry, may be used. The beam and trolley device 60 includes a first beam support 62, a second beam support 64, and a beam 66. The beam and trolley device 60 also includes a trolley 68. A hoist mechanism 70 operatively connects the trolley 68 and the cradle 10. In some embodiments the hoist mechanism 70 and the trolley 68 may be combined in one unit. In the depicted embodiment, chain 30 connects the hoist mechanism 70, the trolley 68, and the cradle 10.

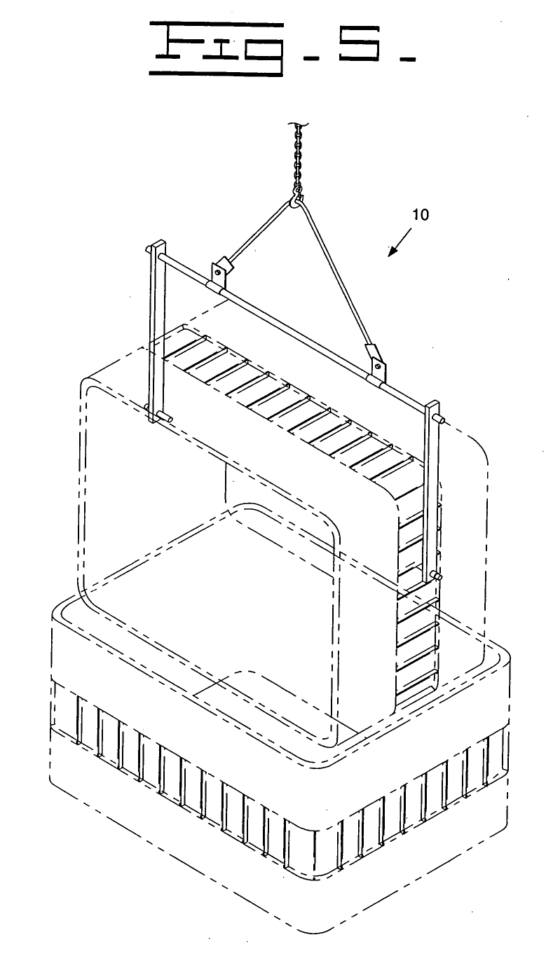

FIGS. 4 and 5 illustrate a method of using the cradle 10. One or more users empties the large box, such as a seed box, and positions the box at a first end 100 of the overhead lifting device 60. The user attaches the cradle 10 to the box. The box is comprised of a first portion and a second portion. For example, when the box is shipped to a seed dealer from the seed company, the first portion sits on top of the second portion. The user positions the pin 16 within a corrugation or recess of the first portion of the box to attach the cradle. In one method, the user positions the pin 16 slightly off-center in the first portion. The user then uses the overhead lifting device 60 to lift the first portion of the box. As the first portion is lifted, it automatically tends to roll over because of the off-center location of the pin 16. The user steadies the upside-down first portion and lowers it over the second portion thereby nesting the two portions for storage and shipping. The user then uses the overhead lifting device 60 to move the box to a second end 110 of the lifting device 60 where the box is then moved to a shipping or storage location.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, while the overhead lifting device is depicted as a beam and trolley device it could equally be an A-frame gantry. Thus, the breadth and scope of the present invention should not be limited by any of the above-described exemplary embodiments, but should be defined only in accordance with the following claims appended hereto and their equivalents.

1. An apparatus for lifting and turning a seed box, the seed box having four walls, at least two opposing walls each having a first outer surface with a first lateral dimension therebetween and the opposing walls each having a second outer surface with a second lateral dimension therebetween, the first lateral dimension being wider than the second lateral dimension, each of the at least two opposing walls defining at least one recess therein, each recess being bounded by ribs, the ribs extending from said first lateral dimension to the second lateral dimension, the apparatus comprising:
a transverse member, said transverse member having a lateral extent greater than the first lateral dimension of the opposing walls of the seed box, said transverse member being adapted to be lifted;
a first plate, said first plate being connected to said transverse member at a first portion of said transverse member;
a second plate, said second plate being connected to said transverse member at a second portion of said transverse member;
said plates being spaced wider than the first lateral dimension of the opposing walls of the seed box;
a first pin, said pin being attached to said first plate, and said pin having an end oriented inwardly relative to said first plate;
a second pin, said second pin being attached to said second plate, and said second pin having an end oriented inwardly relative to said second plate; and
at least one of said first pin or said second pin having a first position and a second position, said first position defining a first distance between said inward ends of said first and second pins, said first distance being wider than the first lateral dimension of the opposing walls of the seed box, and said second position defining a second distance between said inward ends of said first and second pins, said second distance being wider than the second lateral dimension of the opposing walls of the seed box, and said second position being narrower than the first lateral dimension of the opposing walls of the seed box;
whereby, said pins may each engage one recess on each of the opposing walls of the seeds box such that the seed box may be lifted and pivoted.

2. The apparatus of claim 1 further comprising a hanger, said hanger being attached to said transverse member and adapted for lifting.

3. The apparatus of claim 1 further comprising a flat cross member, said flat cross member being attached to said transverse member and adapted for lifting.

4. The apparatus of claim 1 wherein each of said pins is threaded and dimensioned to be screwed into a hole in each of said plates.

5. The apparatus of claim 1 wherein said at least one pin having a first position and a second position includes a spring, said spring biasing said pin towards said second position.

6. The apparatus of claim 5 further comprising a tab, said tab being attached to said pin and said tab being engageable to remove said pin from said second position to said first position.

7. The apparatus of claim 1 further comprising a hoist, said hoist being operatively engaged with said transverse member.

8. The apparatus of claim 7 wherein said hoist is suspended from an overhead lifting frame.

9. The apparatus of claim 1 wherein at least one of said pins is comprised of a hollow housing, said hollow housing being externally threaded and dimensioned for screw mounting on at least one of said first or second plates, said housing having a hollow axis dimension to receive said pin and having a spring dimensioned to seat within said hollow axis in order to bias said pin to extend from said hollow axis.

10. The apparatus of claim 9 further comprising a tab attached to said pin and a slot in said housing, said tab being dimensioned to travel along said slot.

11. A method of lifting and turning a seed box, the seed box having a width and the seed box having recesses on its side walls, the recesses being defined by edges, the method comprising:
bracketing the side walls of the seed box with a first plate and a second plate, said first plate and said second plate each being connected to a transverse member, and each of said first plate and said second plate having a pin, each of said pins extending inwardly, at least one of said pins being further inwardly extendable;
engaging a recess on each of the opposing side walls of the seed box with each of said first and second pins, said engagement being by extending at least one pin inwardly, said extension establishing a distance between pins, said distance being narrower than the outer width of the opposing walls of the seed box; and
dimensioning each of said first pin and said second pin to have a diameter narrower than a space between the edges of the recesses engaged by said first and second pins, such that the seed box pivots around said pins when lifted.

12. The method of claim 11 further comprising attaching a hanger to said transverse member, said hanger being adapted for lifting.

13. The method of claim 11 further comprising attaching a flat cross member to said transverse member, said flat cross member being adapted for lifting.

14. The method of claim 11 further comprising threading each of said pins and dimensioning said threads to be screwed into a hole in each of said plates.

15. The method of claim 11 further comprising configuring said at least one pin to have a first position and a second position and including a spring with said at least one pin, said spring biasing said pin towards said second position.

16. The method of claim 15 further comprising attaching a tab to said pin, said tab being engageable to remove said pin from said second position to said first position.

17. The method of claim 11 further comprising operatively engaging a hoist with said transverse member.

18. The method of claim 17 further comprising suspending said hoist from an overhead lifting frame.

19. The method of claim 11 further comprising hollowing a housing of said at least one pin, said hollow housing being externally threaded and dimensioned for screw mounting on at least one of said first or second plates, said housing having a hollow axis dimension to receive said pin and having a spring dimensioned to seat within said hollow axis in order to bias said at least one pin to extend from said hollow axis.

20. The method of claim 19 further comprising attaching a tab to said pin and a slot in said housing, said tab being dimensioned to travel along said slot.
